(19) United States
(12) Patent Application Publication
(10) Pub. No.: US 2023/0409760 A1
(43) Pub. Date: Dec. 21, 2023

(54) SECURE INPUT METHOD EDITOR FOR VIRTUAL APPLICATIONS

(71) Applicant: Citrix Systems, Inc., Fort Lauderdale, FL (US)

(72) Inventors: Tianze Jiang, Nanjing (CN); Hao Wu, Nanjing (CN)

(21) Appl. No.: 17/861,477

(22) Filed: Jul. 11, 2022

Related U.S. Application Data
(63) Continuation of application No. PCT/CN2022/099728, filed on Jun. 20, 2022.

(51) Int. Cl. G06F 21/83; G06F 21/62

(52) U.S. Cl. CPC G06F 21/83; G06F 21/6227; G06F 21/6245

(57) ABSTRACT

In one aspect, an example methodology implementing the disclosed techniques may include, by a first computing device, detecting a text input to a user interface (UI) element of an application executing on the first computing device and, responsive to the detection of the text input, sending a request for text candidates associated with the text input to a second computing device. The method may also include, responsive to sending the request, receiving, by the first computing device from the second computing device, a list of one or more text candidates associated with the text input. The method may further include presenting, by the first computing device, the list of one or more text candidates in a composition window, the composition window being part of an input method editor (IME) executing on the first computing device, the composition window displayed on a screen of the first computing device.

### CROSS REFERENCE TO RELATED APPLICATIONS

This application is a continuation of and claims the benefit of PCT Patent Application No. PCT/CN2022/099728 filed on Jun. 20, 2022 in the English language in the State Intellectual Property Office and designating the United States, the contents of which are hereby incorporated herein by reference in its entirety.

### BACKGROUND

An input method editor (IME) is an operating system component or program that enables users to generate characters not natively available on their input devices (e.g., physical or virtual keyboard) by using sequences of characters that are natively available on their input devices. Using an IME may be necessary for languages that have more graphemes than there are keys on the keyboard, such as Chinese, Japanese, and Korean languages.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

It is appreciated herein that using a conventional IME provided by a third-party organization can result in a loss of privacy. Many third-party IME software capture the inputs (e.g., text inputs) made by users and, in some cases, upload the captured input to the cloud or a remote device associated with the third-party IME provider. Thus, if the inputs to such IMEs contain sensitive information, such as personally identifiable information (PII), it is very likely that the sensitive information will be lost, leaked, or otherwise compromised. Embodiments of the present disclosure provide an IME solution that solve several technical problems exhibited by some conventional IMEs including capture and uploading of sensitive information, which can lead to undesirable loss of privacy.

In accordance with one example embodiment provided to illustrate the broader concepts, systems, and techniques described herein, a method includes, by a first computing device, detecting a text input to a user interface (UI) element of an application executing on the first computing device and, responsive to the detection of the text input, sending a request for text candidates associated with the text input to a second computing device. The method also includes, responsive to sending the request, receiving, by the first computing device from the second computing device, a list of one or more text candidates associated with the text input. The method further includes presenting, by the first computing device, the list of one or more text candidates in a composition window, the composition window being part of an input method editor (IME) executing on the first computing device, the composition window displayed on a screen of the first computing device.

In some embodiments, the method also includes, responsive to the detection of the text input, disabling, by the first computing device, a local IME of the first computing device.

In some embodiments, the request for text candidates includes an indication of a language associated with the IME.

In some embodiments, the application is a web application.

In some embodiments, the application is a Software as a Service (SaaS) application.

In some embodiments, one or more text candidates associated with the text input is determined based on a query of a candidate repository associated with the second computing device.

In some embodiments, the request for text candidates associated with the text input is sent from the first computing device via a secure network to the second computing device.

According to another illustrative embodiment provided to illustrate the broader concepts described herein, a computing device includes a processor and a non-volatile memory storing computer program code that when executed on the processor, causes the processor to execute a process corresponding to the aforementioned method or any described embodiment thereof.

According to another illustrative embodiment provided to illustrate the broader concepts described herein, a non-transitory machine-readable medium encodes instructions that when executed by one or more processors cause a process to be carried out, the process corresponding to the aforementioned method or any described embodiment thereof.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram of an illustrative network computing environment in which embodiments of the present disclosure may be implemented.

FIG. 2 is a block diagram illustrating selective components of an example computing device in which various aspects of the disclosure may be implemented, in accordance with an embodiment of the present disclosure.

FIG. 3 is a schematic block diagram of a cloud computing environment in which various aspects of the disclosure may be implemented.

FIG. 4A is a block diagram of an illustrative system in which resource management services may manage and streamline access by clients to resource feeds (via one or more gateway services) and/or software-as-a-service (SaaS) applications.

FIG. 4B is a block diagram showing an illustrative implementation of the system shown in FIG. 4A in which various resource management services as well as a gateway service are located within a cloud computing environment.

FIG. 4C is a block diagram similar to FIG. 4B but in which the available resources are represented by a single box labeled “systems of record,” and further in which several different services are included among the resource management services.

FIG. 5 is a diagram of a conventional input method editor (IME) component used on a computing device.

FIG. 6 shows a computing environment having a secure input method editor (IME) for remote applications, in accordance with an embodiment of the present disclosure.

FIG. 7 is a diagram illustrating a portion of a user interface (UI) for selecting a language for an input method of a secure input method editor (IME), in accordance with an embodiment of the present disclosure.

FIG. 8 is a flow diagram of an illustrative process for inputting text to an application using a secure input method editor (IME), in accordance with an embodiment of the present disclosure.

FIG. 9 is a flow diagram of an illustrative process for determining text candidates associated with a text input, in accordance with an embodiment of the present disclosure.

### DETAILED DESCRIPTION

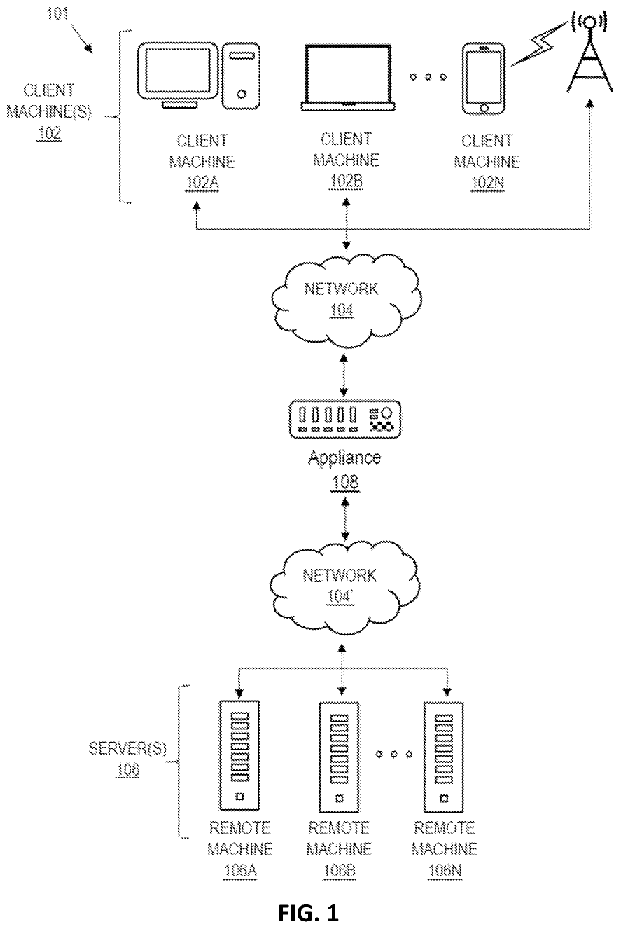

Referring now to FIG. 1, shown is an illustrative network environment 101 of computing devices in which various aspects of the disclosure may be implemented, in accordance with an embodiment of the present disclosure. As shown, environment 101 includes one or more client machines 102A-102N, one or more remote machines 106A-106N, one or more networks 104, 104′, and one or more appliances 108 installed within environment 101. Client machines 102A-102N communicate with remote machines 106A-106N via networks 104, 104′.

In some embodiments, client machines 102A-102N communicate with remote machines 106A-106N via an intermediary appliance 108. The illustrated appliance 108 is positioned between networks 104, 104′ and may also be referred to as a network interface or gateway. In some embodiments, appliance 108 may operate as an application delivery controller (ADC) to provide clients with access to business applications and other data deployed in a datacenter, a cloud computing environment, or delivered as Software as a Service (SaaS) across a range of client devices, and/or provide other functionality such as load balancing, etc. In some embodiments, multiple appliances 108 may be used, and appliance(s) 108 may be deployed as part of network 104 and/or 104′.

Client machines 102A-102N may be generally referred to as client machines 102, local machines 102, clients 102, client nodes 102, client computers 102, client devices 102, computing devices 102, endpoints 102, or endpoint nodes 102. Remote machines 106A-106N may be generally referred to as servers 106 or a server farm 106. In some embodiments, a client device 102 may have the capacity to function as both a client node seeking access to resources provided by server 106 and as a server 106 providing access to hosted resources for other client devices 102A-102N. Networks 104, 104′ may be generally referred to as a network 104. Networks 104 may be configured in any combination of wired and wireless networks.

Server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

Server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, server 106 may execute a remote presentation services program or other program that uses a thin-client or a remote-display protocol to capture display output generated by an application executing on server 106 and transmit the application display output to client device 102.

In yet other embodiments, server 106 may execute a virtual machine providing, to a user of client device 102, access to a computing environment. Client device 102 may be a virtual machine. The virtual machine may be managed by, for example, a hypervisor, a virtual machine manager (VMM), or any other hardware virtualization technique within server 106.

In some embodiments, network 104 may be: a local-area network (LAN); a metropolitan area network (MAN); a wide area network (WAN); a primary public network; and a primary private network. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

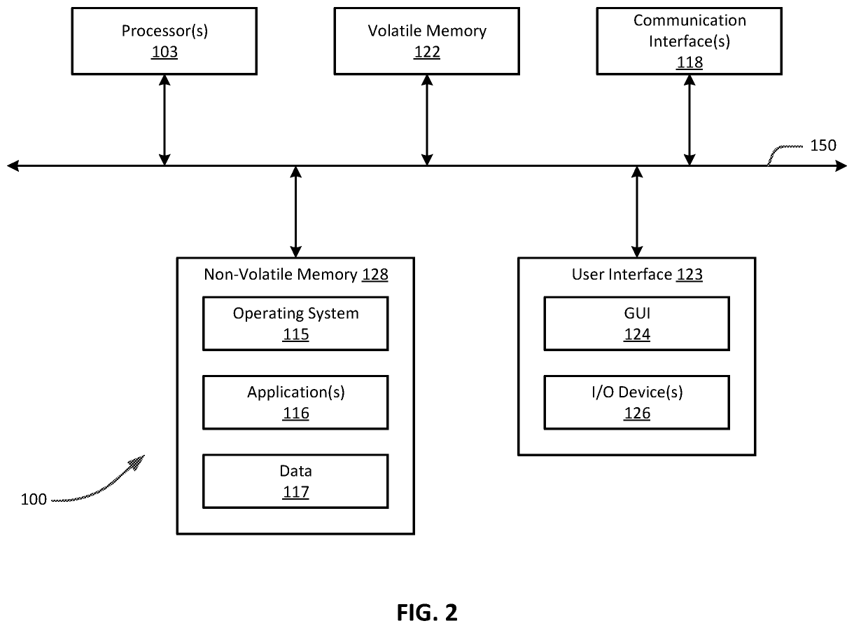

FIG. 2 is a block diagram illustrating selective components of an illustrative computing device 100 in which various aspects of the disclosure may be implemented, in accordance with an embodiment of the present disclosure. For instance, client devices 102, appliances 108, and/or servers 106 of FIG. 1 can be substantially similar to computing device 100. As shown, computing device 100 includes one or more processors 103, a volatile memory 122 (e.g., random access memory (RAM)), a non-volatile memory 128, a user interface (UI) 123, one or more communications interfaces 118, and a communications bus 150.

Non-volatile memory 128 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 123 may include a graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, and one or more accelerometers, etc.).

Non-volatile memory 128 stores an operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computing device 100 may communicate via communications bus 150.

The illustrated computing device 100 is shown merely as an illustrative client device or server and may be implemented by any computing or processing environment with any type of machine or set of machines that may have suitable hardware and/or software capable of operating as described herein.

Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 103 may be analog, digital or mixed signal. In some embodiments, processor 103 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 118 may include one or more interfaces to enable computing device 100 to access a computer network such as a Local Area Network (LAN), a Wide Area Network (WAN), a Personal Area Network (PAN), or the Internet through a variety of wired and/or wireless connections, including cellular connections.

In described embodiments, computing device 100 may execute an application on behalf of a user of a client device. For example, computing device 100 may execute one or more virtual machines managed by a hypervisor. Each virtual machine may provide an execution session within which applications execute on behalf of a user or a client device, such as a hosted desktop session. Computing device 100 may also execute a terminal services session to provide a hosted desktop environment. Computing device 100 may provide access to a remote computing environment including one or more applications, one or more desktop applications, and one or more desktop sessions in which one or more applications may execute.

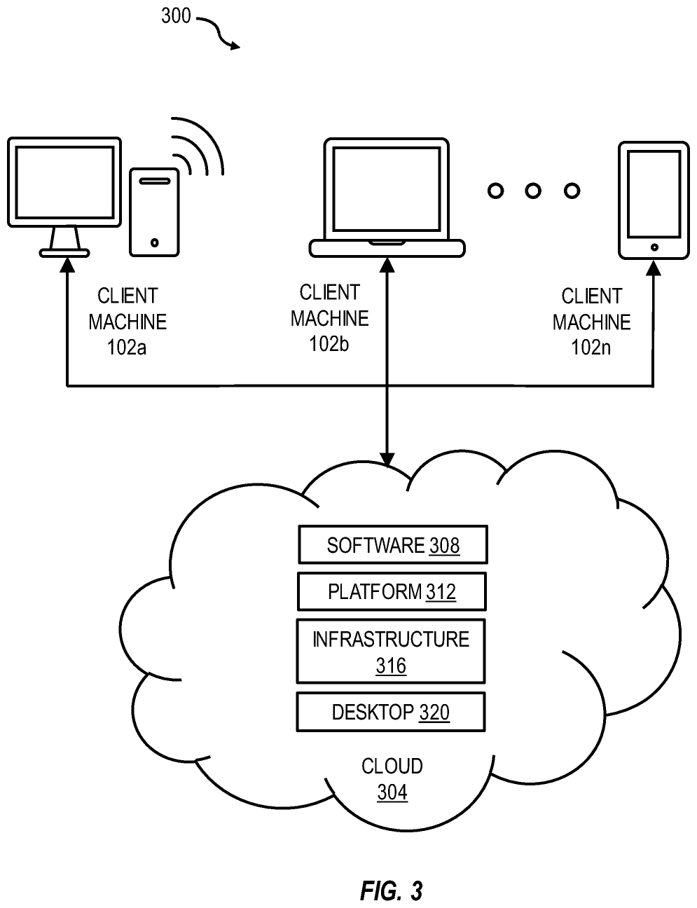

Referring to FIG. 3, a cloud computing environment 300 is depicted, which may also be referred to as a cloud environment, cloud computing or cloud network. Cloud computing environment 300 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In cloud computing environment 300, one or more clients 102a-102n (such as those described above) are in communication with a cloud network 304. Cloud network 304 may include back-end platforms, e.g., servers, storage, server farms or data centers. The users or clients 102a-102n can correspond to a single organization/tenant or multiple organizations/tenants. More particularly, in one illustrative implementation, cloud computing environment 300 may provide a private cloud serving a single organization (e.g., enterprise cloud). In another example, cloud computing environment 300 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, cloud computing environment 300 may provide a hybrid cloud that is a combination of a public cloud and a private cloud. Public clouds may include public servers that are maintained by third parties to clients 102a-102n or the enterprise/tenant. The servers may be located off-site in remote geographical locations or otherwise.

Cloud computing environment 300 can provide resource pooling to serve multiple users via clients 102a-102n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, cloud computing environment 300 can provide on-demand self-service to unilaterally provision computing capabilities (e.g., server time, network storage) across a network for multiple clients 102a-102n. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. Cloud computing environment 300 can provide an elasticity to dynamically scale out or scale in response to different demands from one or more clients 102. In some embodiments, cloud computing environment 300 can include or provide monitoring services to monitor, control and/or generate reports corresponding to the provided shared services and resources.

In some embodiments, cloud computing environment 300 may provide cloud-based delivery of different types of cloud computing services, such as Software as a service (SaaS) 308, Platform as a Service (PaaS) 312, Infrastructure as a Service (IaaS) 316, and Desktop as a Service (DaaS) 320, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g., Citrix ShareFile from Citrix Systems, DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Washington (herein “Azure”), or AMAZON WEB SERVICES provided by Amazon.com, Inc., of Seattle, Washington (herein “AWS”), for example. In the case of Citrix Cloud, Citrix Workspace app may be used as a single-entry point for bringing apps, files and desktops together (whether on-premises or in the cloud) to deliver a unified experience.

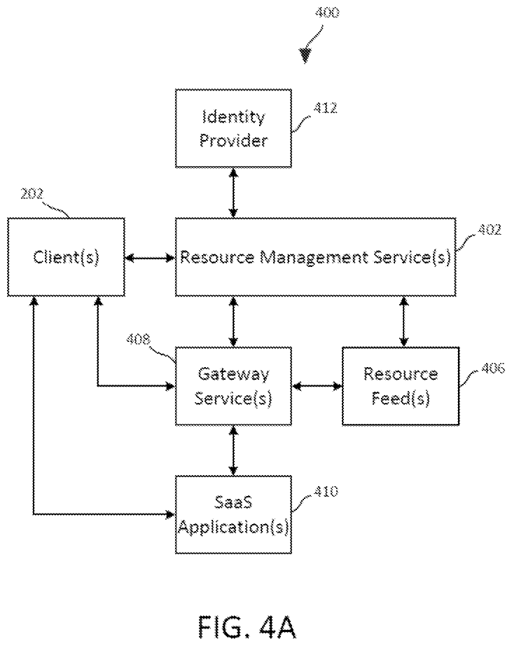

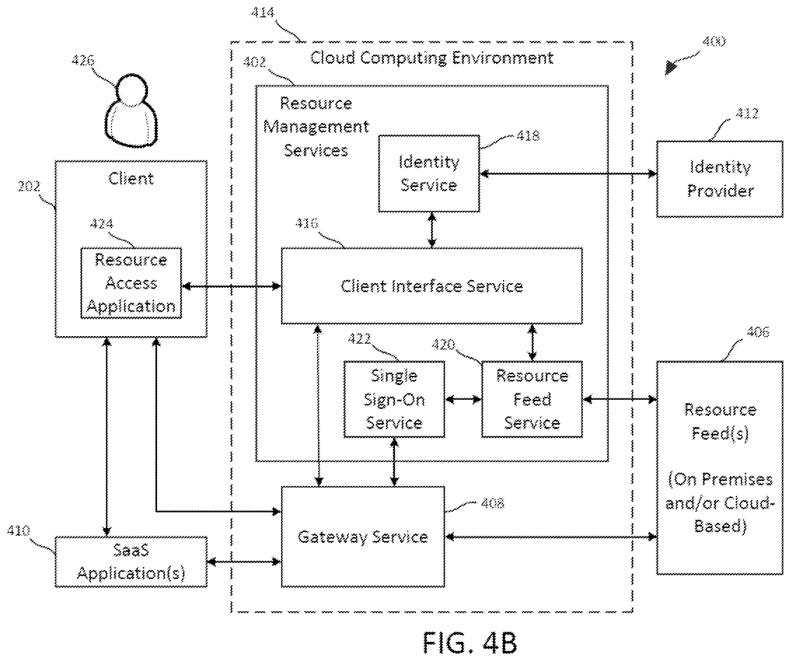

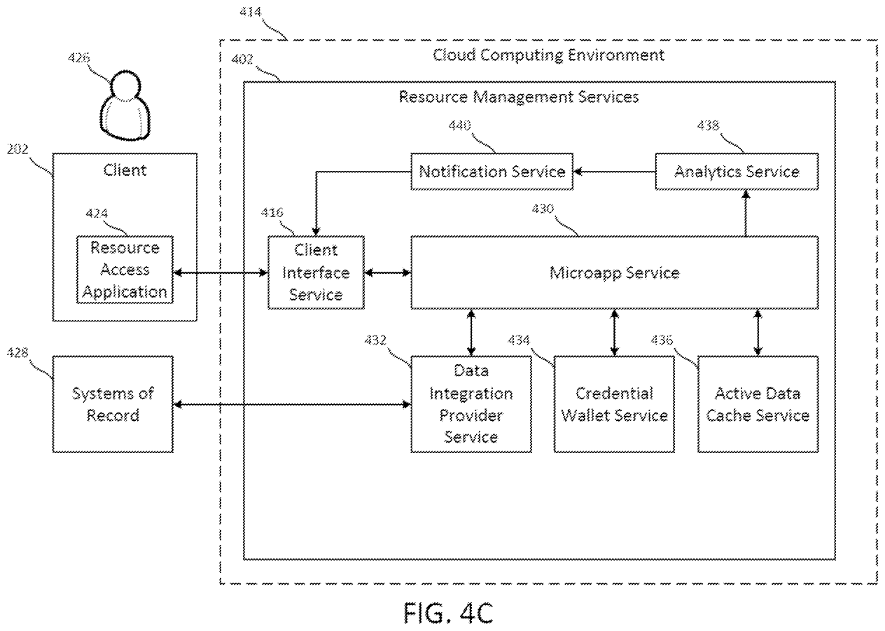

FIG. 4A is a block diagram of an illustrative system 400 in which one or more resource management services 402 may manage and streamline access by one or more clients 202 to one or more resource feeds 406 (via one or more gateway services 408) and/or one or more software-as-a-service (SaaS) applications 410. In particular, resource management service(s) 402 may employ an identity provider 412 to authenticate the identity of a user of a client 202 and, following authentication, identify one of more resources the user is authorized to access. In response to the user selecting one of the identified resources, resource management service(s) 402 may send appropriate access credentials to the requesting client 202, and the requesting client 202 may then use those credentials to access the selected resource. For resource feed(s) 406, client 202 may use the supplied credentials to access the selected resource via gateway service 408. For SaaS application(s) 410, client 202 may use the credentials to access the selected application directly.

Client(s) 202 may be any type of computing devices capable of accessing resource feed(s) 406 and/or SaaS application(s) 410, and may, for example, include a variety of desktop or laptop computers, smartphones, tablets, etc. Resource feed(s) 406 may include any of numerous resource types and may be provided from any of numerous locations. In some embodiments, for example, resource feed(s) 406 may include one or more systems or services for providing virtual applications and/or desktops to client(s) 202, one or more file repositories and/or file sharing systems, one or more secure browser services, one or more access control services for SaaS applications 410, one or more management services for local applications on client(s) 202, one or more internet enabled devices or sensors, etc. Each of resource management service(s) 402, resource feed(s) 406, gateway service(s) 408, SaaS application(s) 410, and identity provider 412 may be located within an on-premises data center of an organization for which system 400 is deployed, within one or more cloud computing environments, or elsewhere.

FIG. 4B is a block diagram showing an illustrative implementation of system 400 shown in FIG. 4A in which various resource management services 402 as well as gateway service 408 are located within a cloud computing environment 414. The cloud computing environment may, for example, include Microsoft Azure Cloud, Amazon Web Services, Google Cloud, or IBM Cloud.

For any of illustrated components (other than client 202) that are not based within cloud computing environment 414, cloud connectors (not shown in FIG. 4B) may be used to interface those components with cloud computing environment 414. Such cloud connectors may, for example, run on Windows Server instances hosted in resource locations and may create a reverse proxy to route traffic between the site(s) and cloud computing environment 414. In the illustrated example, the cloud-based resource management services 402 include a client interface service 416, an identity service 418, a resource feed service 420, and a single sign-on service 422. As shown, in some embodiments, client 202 may use a resource access application 424 to communicate with client interface service 416 as well as to present a user interface on client 202 that a user 426 can operate to access resource feed(s) 406 and/or SaaS application(s) 410. Resource access application 424 may either be installed on client 202 or may be executed by client interface service 416 (or elsewhere in system 400) and accessed using a web browser (not shown in FIG. 4B) on client 202.

As explained in more detail below, in some embodiments, resource access application 424 and associated components may provide user 426 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When resource access application 424 is launched or otherwise accessed by user 426, client interface service 416 may send a sign-on request to identity service 418. In some embodiments, identity provider 412 may be located on the premises of the organization for which system 400 is deployed. Identity provider 412 may, for example, correspond to an on-premises Windows Active Directory. In such embodiments, identity provider 412 may be connected to the cloud-based identity service 418 using a cloud connector (not shown in FIG. 4B), as described above. Upon receiving a sign-on request, identity service 418 may cause resource access application 424 (via client interface service 416) to prompt user 426 for the user's authentication credentials (e.g., username and password). Upon receiving the user's authentication credentials, client interface service 416 may pass the credentials along to identity service 418, and identity service 418 may, in turn, forward them to identity provider 412 for authentication, for example, by comparing them against an Active Directory domain. Once identity service 418 receives confirmation from identity provider 412 that the user's identity has been properly authenticated, client interface service 416 may send a request to resource feed service 420 for a list of subscribed resources for user 426.

In other embodiments (not illustrated in FIG. 4B), identity provider 412 may be a cloud-based identity service, such as a Microsoft Azure Active Directory. In such embodiments, upon receiving a sign-on request from client interface service 416, identity service 418 may, via client interface service 416, cause client 202 to be redirected to the cloud-based identity service to complete an authentication process. The cloud-based identity service may then cause client 202 to prompt user 426 to enter the user's authentication credentials. Upon determining the user's identity has been properly authenticated, the cloud-based identity service may send a message to resource access application 424 indicating the authentication attempt was successful, and resource access application 424 may then inform client interface service 416 of the successfully authentication. Once identity service 418 receives confirmation from client interface service 416 that the user's identity has been properly authenticated, client interface service 416 may send a request to resource feed service 420 for a list of subscribed resources for user 426.

For each configured resource feed, resource feed service 420 may request an identity token from single sign-on service 422. Resource feed service 420 may then pass the feed-specific identity tokens it receives to the points of authentication for the respective resource feeds 406. Each resource feed 406 may then respond with a list of resources configured for the respective identity. Resource feed service 420 may then aggregate all items from the different feeds and forward them to client interface service 416, which may cause resource access application 424 to present a list of available resources on a user interface of client 202. The list of available resources may, for example, be presented on the user interface of client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on client 202, and/or one or more SaaS applications 410 to which user 426 has subscribed. The lists of local applications and SaaS applications 410 may, for example, be supplied by resource feeds 406 for respective services that manage which such applications are to be made available to user 426 via resource access application 424. Examples of SaaS applications 410 that may be managed and accessed as described herein include Microsoft Office 365 applications, SAP SaaS applications, Workday applications, etc.

For resources other than local applications and SaaS application(s) 410, upon user 426 selecting one of the listed available resources, resource access application 424 may cause client interface service 416 to forward a request for the specified resource to resource feed service 420. In response to receiving such a request, resource feed service 420 may request an identity token for the corresponding feed from single sign-on service 422. Resource feed service 420 may then pass the identity token received from single sign-on service 422 to client interface service 416 where a launch ticket for the resource may be generated and sent to resource access application 424. Upon receiving the launch ticket, resource access application 424 may initiate a secure session to gateway service 408 and present the launch ticket. When gateway service 408 is presented with the launch ticket, it may initiate a secure session to the appropriate resource feed and present the identity token to that feed to seamlessly authenticate user 426. Once the session initializes, client 202 may proceed to access the selected resource.

When user 426 selects a local application, resource access application 424 may cause the selected local application to launch on client 202. When user 426 selects SaaS application 410, resource access application 424 may cause client interface service 416 request a one-time uniform resource locator (URL) from gateway service 408 as well a preferred browser for use in accessing SaaS application 410. After gateway service 408 returns the one-time URL and identifies the preferred browser, client interface service 416 may pass that information along to resource access application 424. Client 202 may then launch the identified browser and initiate a connection to gateway service 408. Gateway service 408 may then request an assertion from single sign-on service 422. Upon receiving the assertion, gateway service 408 may cause the identified browser on client 202 to be redirected to the logon page for identified SaaS application 410 and present the assertion. The SaaS may then contact gateway service 408 to validate the assertion and authenticate user 426. Once the user has been authenticated, communication may occur directly between the identified browser and the selected SaaS application 410, thus allowing user 426 to use client 202 to access the selected SaaS application 410.

In some embodiments, the preferred browser identified by gateway service 408 may be a specialized browser embedded in resource access application 424 (when the resource application is installed on client 202) or provided by one of the resource feeds 406 (when resource access application 424 is located remotely), e.g., via a secure browser service. In such embodiments, SaaS applications 410 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 406) for assessment of its security risk by a web filtering service. For approved URLs, the specialized browser may be permitted to access the link. For suspicious links, however, the web filtering service may have client interface service 416 send the link to a secure browser service, which may start a new virtual browser session with client 202, and thus allow the user to access the potentially harmful linked content in a safe environment.

In some embodiments, in addition to or in lieu of providing user 426 with a list of resources that are available to be accessed individually, as described above, user 426 may instead be permitted to choose to access a streamlined feed of event notifications and/or available actions that may be taken with respect to events that are automatically detected with respect to one or more of the resources. This streamlined resource activity feed, which may be customized for each user 426, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to each event right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify user 426 of something that requires the user's attention (e.g., approval of an expense report, new course available for registration, etc.).

FIG. 4C is a block diagram similar to that shown in FIG. 4B but in which the available resources (e.g., SaaS applications, web applications, Windows applications, Linux applications, desktops, file repositories and/or file sharing systems, and other data) are represented by a single box 428 labeled “systems of record,” and further in which several different services are included within the resource management services block 402. As explained below, the services shown in FIG. 4C may enable the provision of a streamlined resource activity feed and/or notification process for client 202. In the example shown, in addition to client interface service 416 discussed above, the illustrated services include a microapp service 430, a data integration provider service 432, a credential wallet service 434, an active data cache service 436, an analytics service 438, and a notification service 440. In various embodiments, the services shown in FIG. 4C may be employed either in addition to or instead of the different services shown in FIG. 4B.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within resource access application 424 without having to launch the native application. The system shown in FIG. 4C may, for example, aggregate relevant notifications, tasks, and insights, and thereby give user 426 a dynamic productivity tool. In some embodiments, the resource activity feed may be intelligently populated by utilizing machine learning and artificial intelligence (AI) algorithms. Further, in some implementations, microapps may be configured within cloud computing environment 414, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 4C, systems of record 428 may represent the applications and/or other resources resource management services 402 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. Resource management services 402, and in particular data integration provider service 432, may, for example, support REST API, JSON, OData-JSON, and 6 ML. As explained in more detail below, data integration provider service 432 may also write back to the systems of record, for example, using OAuth2 or a service account.

In some embodiments, microapp service 430 may be a single-tenant service responsible for creating the microapps. Microapp service 430 may send raw events, pulled from systems of record 428, to analytics service 438 for processing. The microapp service may, for example, periodically pull active data from systems of record 428.

In some embodiments, active data cache service 436 may be single-tenant and may store all configuration information and microapp data. It may, for example, utilize a per-tenant database encryption key and per-tenant database credentials.

In some embodiments, credential wallet service 434 may store encrypted service credentials for systems of record 428 and user OAuth2 tokens.

In some embodiments, data integration provider service 432 may interact with systems of record 428 to decrypt end-user credentials and write back actions to systems of record 428 under the identity of the end-user. The write-back actions may, for example, utilize a user's actual account to ensure all actions performed are compliant with data policies of the application or other resource being interacted with.

In some embodiments, analytics service 438 may process the raw events received from microapps service 430 to create targeted scored notifications and send such notifications to notification service 440.

Finally, in some embodiments, notification service 440 may process any notifications it receives from analytics service 438. In some implementations, notification service 440 may store the notifications in a database to be later served in a notification feed. In other embodiments, notification service 440 may additionally or alternatively send the notifications out immediately to client 202 as a push notification to user 426.

In some embodiments, a process for synchronizing with systems of record 428 and generating notifications may operate as follows. Microapp service 430 may retrieve encrypted service account credentials for systems of record 428 from credential wallet service 434 and request a sync with data integration provider service 432. Data integration provider service 432 may then decrypt the service account credentials and use those credentials to retrieve data from systems of record 428. Data integration provider service 432 may then stream the retrieved data to microapp service 430. Microapp service 430 may store the received systems of record data in active data cache service 436 and also send raw events to analytics service 438. Analytics service 438 may create targeted scored notifications and send such notifications to notification service 440. Notification service 440 may store the notifications in a database to be later served in a notification feed and/or may send the notifications out immediately to client 202 as a push notification to user 426.

In some embodiments, a process for processing a user-initiated action via a microapp may operate as follows. Client 202 may receive data from microapp service 430 (via client interface service 416) to render information corresponding to the microapp. Microapp service 430 may receive data from active data cache service 436 to support that rendering. User 426 may invoke an action from the microapp, causing resource access application 424 to send that action to microapp service 430 (via client interface service 416). Microapp service 430 may then retrieve from credential wallet service 434 an encrypted Oauth2 token for the system of record for which the action is to be invoked and may send the action to data integration provider service 432 together with the encrypted Oath2 token. Data integration provider service 432 may then decrypt the Oath2 token and write the action to the appropriate system of record under the identity of user 426. Data integration provider service 432 may then read back changed data from the written-to system of record and send that changed data to microapp service 430. Microapp service 432 may then update active data cache service 436 with the updated data and cause a message to be sent to resource access application 424 (via client interface service 416) notifying user 426 that the action was successfully completed.

In some embodiments, in addition to or in lieu of the functionality described above, resource management services 402 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, resource management services 402 may enable virtual assistance functionality that allows users to remain productive and take quick actions. Users may, for example, interact with the “Virtual Assistant” and ask questions such as “What is Bob Smith's phone number?” or “What absences are pending my approval?” Resource management services 402 may, for example, parse these requests and respond because they are integrated with multiple systems on the backend. In some embodiments, users may be able to interact with the virtual assistance through either resource access application 424 or directly from another resource, such as Microsoft Teams. This feature may allow employees to work efficiently, stay organized, and deliver only the specific information they're looking for.

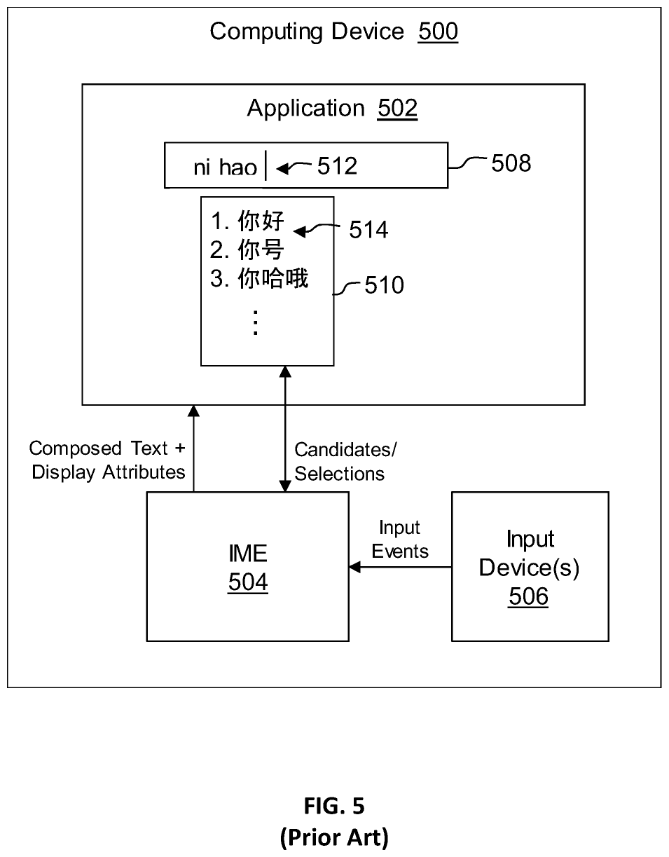

FIG. 5 illustrates a conventional input method editor (IME) used on a computing device 500. Illustrative computing device 500 can include one more applications (e.g., an application 502), one or more IMEs 504, and one or more input devices 506. A given IME 504 can be provided as an operating system (OS) component or as a standalone program, e.g., an application installed on computing device 500 separate from the OS. A user may choose to install one or more IMEs on their computing device 500 that differ in terms of appearance and/or functionality. For example, IME 504 may be provided by a third-party (i.e., an organization other than the organization associated with the user of computing device 500). Applications 502 and IMEs 504 may be embodied as computer-executable instructions stored on a computer readable storage medium (not shown) and executable by one or more processors (not shown) of computing device 500. To promote clarity in the drawings, only one application 502 and one IME 504 are shown in FIG. 5. Moreover, various hardware and/or software components that may be found in a conventional computing device are omitted from FIG. 5 for clarity.

IME 504 can include, or otherwise be associated with, a composition window 508 and a candidates window 510. Composition window 508 and candidates window 510 form the user interface (UI) for IME 504. A conventional IME can include additional UI elements not shown in the simplified example of FIG. 5, such as a status window by which a user can set a conversion mode for IME 504 (e.g., which language and/or alphabet is being used by IME 504). In response to keystrokes and/or other inputs produced by a user, IME 504 generates composed text which is displayed within a composing string 512 of composition window 508. Keystrokes can be received from a physical keyboard, a virtual keyboard, or other type of input device 506. The composed text generated by IME 504 can include the keystrokes as directly entered by the user or may include converted text that is generated and/or chosen based on such keystrokes. Composition window 508 can receive the composed text and update composing string 512 accordingly. Composing string 512 corresponds to the current text (e.g., word or phrase) being entered in the composition window 508.

Candidates window 510 appears in conjunction with composition window 508 and includes a list of alternative text, or candidates 514, selected or generated by IME 504 based on characters within composing string 512. The alternative text (i.e., candidates 514) are in the language selected (e.g., configured) for the input method of IME 504. Each of candidates 514 can include a single character or multiple characters, as shown in FIG. 5. The user can scroll through candidates 514 and select the desired characters using a mouse, touchscreen, or other input device 506. In some implementations, the candidates within candidates 514 may be labeled (e.g., “1,” “2,” etc.) and the user can press a corresponding key to select a candidate within candidates 514. In response, in some implementations, IME 504 can send the selected character(s) to composition window 508 for display within composition window 508. Candidates window 510 may be positioned below, above, or otherwise near to composing string 512 such that a user can easily view and select candidates 514 while composing text.

As shown in FIG. 5, in some implementations, composition window 508 and candidates window 510 may be implemented as part of application 502. In more detail, IME 504 may provide an application programming interface (API) that application 502 can use to interface with IME 504. Examples of IME APIs include Input Method Manager (IMM) on WINDOWS and Input Method Editor API, a standard API for web browsers. Using a provided IME API, application 502 can use IME functions and messages to create and manage their own IME windows, providing a custom interface while using the conversion capabilities of the IME. In other examples, composition window 508 and/or candidates window 510 may be implemented by IME 504.

IME 504 may track the status of composing string 512 over time. This status can include attribute information, clause information, typing information, and text cursor position (also known as the caret position). IME 504 can log and collect the characters within composing string 512. For example, IME 504 can collect the characters within composing string 512 in order to improve the user's experience in using IME 504. In some cases, IME 504 may periodically send the collected characters (e.g., collected user inputs) outside of computing device 504 such as to the cloud or a remote server, resulting in input leakage and security and privacy concerns to the user.

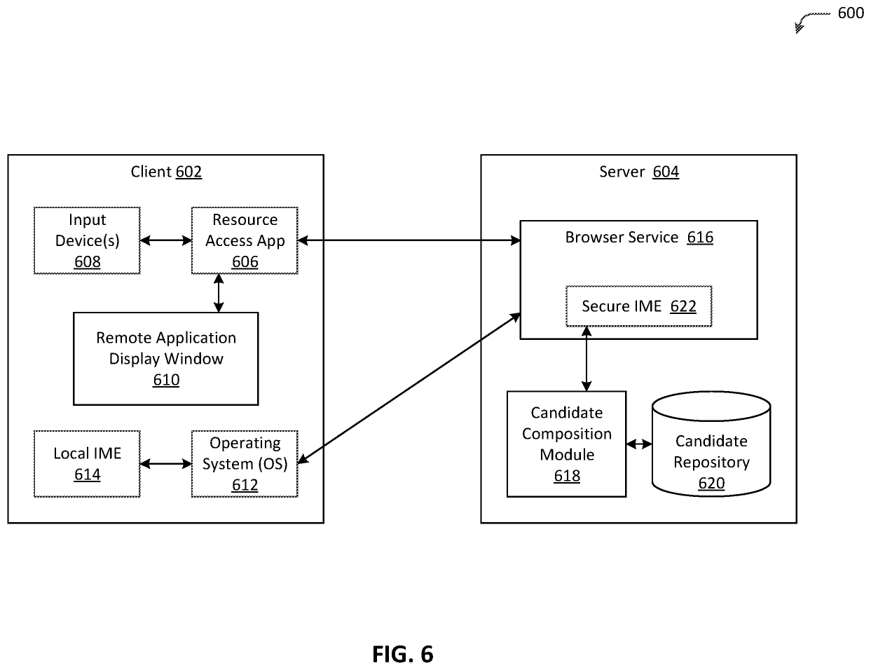

FIG. 6 shows a computing environment having a secure IME for remote applications, in accordance with an embodiment of the present disclosure. The structures and techniques described herein can overcome various technical problems found in some IME implementations, such as the technical problems discussed above in conjunction with the IME implementation of FIG. 5.

An illustrative computing environment 600 includes a client 602 and a server 604 which may be connected via one or more computer networks (not shown) such as the Internet or another wide area network (WAN). In the example shown, a resource access application 606 installed on client 602 can be used to access an application (e.g., SaaS application, web application, etc.) provided by a browser service 616 hosted on server 604. In general, browser service 616 may provide one or more clients with access to one or more remote applications running on server 604. In some examples, client 602 can accesses the application running on server 604 using a remote display protocol such as Independent Computing Architecture (ICA) or the Remote Desktop Protocol (RDP). The remote display protocol can include a set of data transfer rules that allow for applications and desktops hosted on server 604 to be displayed on remote client 602 and to receive various types of inputs therefrom. To promote clarity in the drawings, FIG. 6 shows a single resource access application 606 communicably coupled to browser service 616. However, embodiments of browser service 616 can be used to service many resource access applications (e.g., resource access applications 606) installed on clients (e.g., clients 602) associated with one or more organizations.

In some embodiments, client 602 and/or server 604 may include various hardware and/or software components similar to those described above in the context of client device 102 of FIG. 1 and device 100 of FIG. 2. In some embodiments, client 602 and server 604 may form a part of a cloud computing environment, such as cloud computing environment 300 of FIG. 3 described above. In some embodiments, client 602 and server 604 may run different OS's. For example, client 602 may run WINDOWS or MACOS and server 604 may run Linux.

Resource access application 606 and associated components may provide a user with a personalized, all-in-one interface enabling seamless access to the user's resources, such as SaaS and web applications, files, virtual Windows applications, virtual Linux applications, desktops, mobile applications, Citrix Virtual Apps and Desktops™, local applications, and other data. In one example, resource access application 606 may correspond to the CITRIX WORKSPACE app. In an implementation, resource access application 606 may include a web browser for accessing web-based SaaS applications along with other types of web apps and websites. In some embodiments, resource access application 606 may be the same or similar to resource access application 424 of FIGS. 4A-4B described above.

In addition to resource access application 606, client 602 also includes one or more input devices 608, a remote application display window 610, an operating system (OS) 612, and a local IME 614, among other hardware and/or software components not shown to promote clarity in the drawing. Input devices 608 can include a physical or virtual input devices (e.g., keyboards, mice, touchscreens, etc.) that generate input events in response to user inputs. Such input events can include keystrokes, mouse clicks, touch events, etc. Client 602 can include device drivers to handle input from corresponding ones of the input devices 606. Resource access application 606 receives input events from input devices 608 and sends them to server 604. In addition, resource access application 606 receives remote display information from server 604 and, using this remote display information, causes a remote application which is being accessed to be displayed within remote application display window 610 on client 602. In embodiments where resource access application i606 s implemented as a browser-based client, such as an HTML5 client, remote application display window 610 may correspond to a browser window. OS 612 may provide the computing environment (e.g., a windowing environment whereby a particular remote application can be displayed within remote application display window 610) of client 602. Non-limiting examples of OS 612 include WINDOWS, MACOS, CHROME OS, and various LINUX/UNIX distributions. OS 612 may provide an API to access and interface with local IME 614. Local IME 614 may be a conventional IME that is provided with OS 612 or by a third party. For example, local IME 614 may be the same or similar to IME 504 of FIG. 5 described above.

Server 604 includes browser service 616, a candidate composition module 618, and a candidate repository 620, among other hardware and/or software components not shown to promote clarity in the drawing. As mentioned previously, browser service 616 may provide one or more clients with access to one or more remote applications running on server 604. Browser service 606 can be hosted within a cloud computing environment associated with an organization (e.g., cloud computing environment 414 of FIGS. 4B-4C or a different cloud computing environment) or within an on-premises data center (e.g., an on-premises data center of an organization that utilizes browser service 606). Server 604 can be provided within an on-premise data center (e.g., an on-premises data center of an organization that utilizes browser service 606).

In some embodiments, browser service 616 may be a secure browser service, such as the CITRIX SECURE BROWSER SERVICE, which provides a remote web browser with enhanced security features. For example, the remote web browser may isolate web browsing to protect a corporate network from browser-based attacks. In some embodiments, the remote browser may be based on Chromium. The structures and techniques described herein are not limited to use with remote web browsers and can generally be used in conjunction with any type of remotely accessed application, such as a SaaS application.

Server-side browser service 616 includes a secure IME 622. In an implementation, secure IME 622 may be implemented as a plugin (i.e., software code or a software component that enables an existing application or program to perform a function it could not otherwise perform; stated differently, the plugin adds a specific feature or functionality to an existing application or program) on browser service 616. Secure IME 622 and candidate composition module 618 can interoperate to provide a secure IME experience as described herein.

To this end, secure IME 622 can communicate with candidate composition module 618 using an API (e.g., REST-based API or a Hypertext Transfer Protocol (HTTP)-based API). For example, secure IME 622 can send requests (or “messages”) to candidate composition module 618 wherein the requests are received and processed by candidate composition module 618 or one or more components of candidate composition module 618. Likewise, candidate composition module 618 can send responses/messages to secure IME 602 wherein the responses/messages are received and processed by secure IME 602 or one or more components of secure IME 602.

In some embodiments, secure IME 622 may be selectively enabled. For example, in one such embodiment, a web browser (e.g., secure web browser) provided by browser service 616 can include a UI element, such as a button or icon, that can be used to select a language for the input method of secure IME 622 and cause secure IME 622 to be enabled. For example, a user can use the provided UI element to select a language, such as, for example, Chinese, Japanese, or Korean, for the input method of IME 622. Selecting a language for IME 622 in such manner enables IME 622. In other embodiments, IME 622 may be separately enabled using a provided UI element different than the UI element used for selecting a language for the input method of secure IME 622. In response to being enabled, secure IME 622 can send a message to browser service 616 that causes browser service 616 to disable conventional IMEs (e.g., local IME 614) which may be installed on client 602. For example, browser service 616 may utilize an API provided by OS 612 on client 602 to disable local IME 614.

When enabled, secure IME 622 is operable to determine which of the input events received by server 604 from resource access application 606 are to input areas (e.g., UI elements/control) of an application being accessed and displayed within remote application display window 610. Such input events are sometimes referred to herein as IME input events. In response to determining (or “detecting”) IME input events, secure IME 622 can generate text input for display within a composition window of the application which is being accessed and displayed within remote application display window 610 on client 602. Secure IME 622 can also present a list of text candidates (also known as alternative text) within a candidates window of the application. Note that, disabling the conventional IMEs when secure IME 622 is enabled prevents the conventional IMEs from capturing user inputs to an application on client 602 (e.g., inputs to remote application display window 610) and uploading the captured input to the cloud or remote device outside the environment of browser service 606 which includes secure IME 622. As a result, any sensitive information which may be included in the input events is secure in that the sensitive information is not sent outside browser service 606. Rather, since secure IME 622 is implemented within or as part of browser service 606, the input events, and any sensitive information included in the input events, remain within browser service 606 and in control of the organization associated with browser service 606.

With continued reference to the server-side browser service 616, secure IME 622 may also track the status of the text displayed within the composition window over time. This status can include, for example, typing information and text cursor position (also known as the caret position). The composition window and/or candidates window may be implemented by the application or by secure IME 622. The composition window may correspond to an active text input of the application displayed within remote application display window 610 on client 602. As used herein, the term “text input” refers to any type of UI element/control that can receive keystrokes entered by a user. The term “active text input” herein refers to a text input of an application that currently has focus or is otherwise configured to receive keystrokes for the application at the current time. A particular text input of an application may become the active text input when it gains focus and may cease to be the active text input when it loses focus (i.e., an application's active text input can change over time).

In some embodiments, some or all of the text candidates presented within the candidates window may be provided by candidate composition module 618. For example, upon detecting an IME input event, secure IME 622 may send a request to candidate composition module 618 for a list of text candidates associated with the text input (e.g., the text input of the IME input event produced by the user). The request may include an indication of a language (e.g., Chinese, Japanese, Korean, etc.) associated with secure IME 622 (e.g., specify a language for the text candidates). The language associated with secure IME 622 is the language selected for the input method of secure IME 622. In response to receiving such a request, candidate composition module 618 may query or otherwise retrieve from candidate repository 620 the text candidate(s) associated with the text input. Candidate repository 620 can correspond to, for example, a storage service, and may store the text candidates which can be provided by candidate composition module 618. Candidate composition module 618 may then send the text candidates associated with the text input to secure IME 622. By way of an example, if Chinese (e.g., Chinese Pinyin IME) is selected for the input method of secure IME 622, the text candidates returned by candidate composition module 618 for the text input “a” may include [symbol] Secure IME 622 may then present the list of text candidates provided by candidate composition module 618 within the candidates window.

In some embodiments, secure IME 622 and candidate composition module 618 may communicate via a secure network of the organization (e.g., a secure network of the organization associated with browser service 606). For example, requests for text candidates and responses to such requests for text candidates may be sent and received via the secure network. Utilization of the organization's secure network may provide additional security for the input events received and processed by secure IME 622.

In operation, a user of client 602 can use resource access application 606 (e.g., a secure web browser) provided by browser service 616 to access (e.g., launch) a web or SaaS application. The accessed application may be a remote application running on server 604. Prior to generating an input event, the user can use a UI element of resource access application 606 to enable secure IME 622 of browser service 616. The user can also use the same or a different UI element to select a language for the input method of secure IME 622. When secure IME 622 is enabled, secure IME 622 can send a notification that causes browser service 616 to disable the conventional IMEs on client 602. As the user generates inputs (e.g., text inputs) to the application, resource access application 606 can send input events to server 604, and secure IME 622 can detect the IME input events. Responsive to detecting an IME input event (i.e., a text input to an input area of the application), secure IME 622 can receive a list of text candidates associated with the text input of the IME input event. Secure IME 622 can present the list of text candidates within a candidates window displayed on client 602. In one embodiment, the candidates window may be implemented as a popup window that is displayed at or proximate the current caret position within remote application display window 610. The user can then select a text candidate from the list of text candidates displayed within the candidates window and commit the selected text candidate for input to the application (e.g., the user can press an “Enter” key to commit the selected text candidate). In response, secure IME 622 can input (e.g., write) the selected text candidate to the appropriate input area of the application and close the displayed candidates window (e.g., no longer display the list of text candidates).

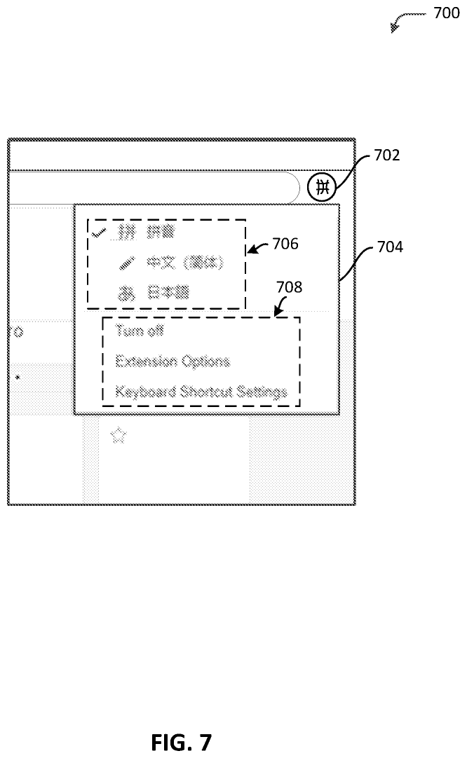

Turning to FIG. 7 and with continued reference to FIG. 6, shown is a diagram illustrating a portion of a user interface (UI) 700 for selecting a language for an input method of secure IME 622, in accordance with an embodiment of the present disclosure. UI 700 may be implemented within a resource access application, such as resource access application 606. Alternatively, UI 700 or portions thereof can be implemented within other types of applications which can be used to launch remote applications. For example, UI 700 can be implemented within a web browser application on client 602.

As shown, UI 700 includes a UI element 702 which can be used to select a language for the input method of secure IME 622. UI element 702 may be included within an extensions bar of UI 700. For example, a user can click/tap/select UI element 702 to display a popup menu 704 having one or more menu items 706 for selecting a language for the input method. The individual menu items 706 can correspond to a particular language supported by secure IME 622. When the user clicks on or otherwise selects one of the one or more menu items 706, the language corresponding to the clicked-on menu item 706 is selected and the input method of secure IME 622 is configured for the selected language. In the example of FIG. 7, popup menu 704 can include other menu items 708 (e.g., “Turn off”, “Extension Options”, and “Keyboard Shortcut Settings”) for configuring various aspects of secure IME 622. For example, the user can click on or otherwise select the “Turn off” menu item to turn off or disable secure IME 622. In the disabled state, a menu item “Turn on” may display within popup menu 704 to indicate that secure IME 622 is currently turned off or disabled. The user can then click on or otherwise select the “Turn on” menu item to turn on or enable secure IME 622.

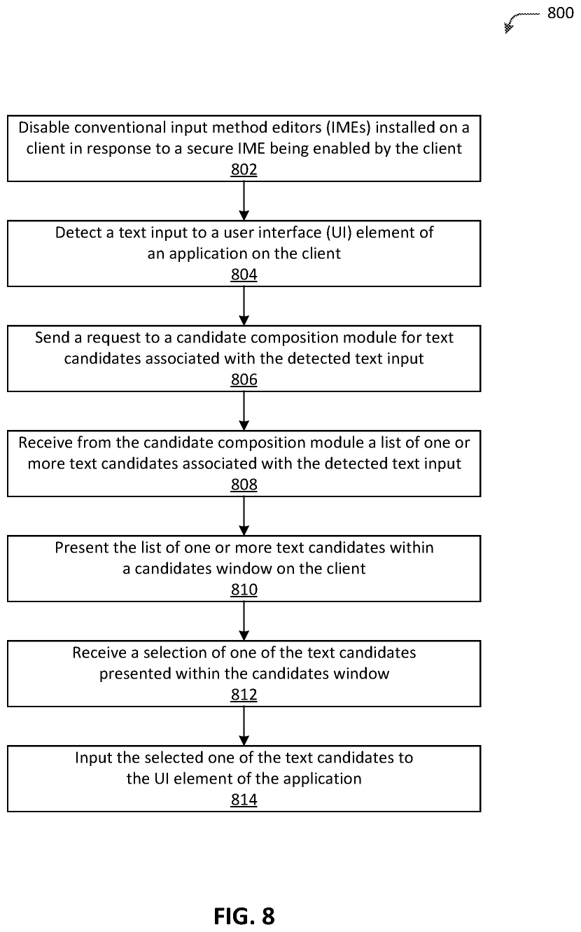

FIG. 8 is a flow diagram of an illustrative process 800 for inputting text to an application using a secure input method editor (IME), in accordance with an embodiment of the present disclosure. Illustrative process 800 may be implemented, for example, within the client-server computing environment 600 of FIG. 6. In more detail, process 800 may be performed by one or more components of a server, such as server 604, of computing environment 600 of FIG. 6. In the following description, it is assumed that a client within the client-server computing environment, such as client 602 of FIG. 6, is accessing a remote application running on the server.

Referring to process 800, at 802, conventional IMEs installed on the client can be disabled in response to a secure IME of the server being enabled by the client. In some embodiments, the secure IME may be enabled by or using a resource access application, such as resource access application 606 of FIG. 6, that is being utilized to access the remote application. The conventional IMEs may be disabled using APIs provided by an OS on the client.

At 804, a text input to a UI element of the remote application can be detected. For example, the secure IME can detect a text input to a UI element of the remote application by examining the input events received by the server from the client.

At 806, the secure IME can send a request to a candidate composition module for text candidates associated with the detected text input. In some embodiments, the candidate composition module may be on the server. In other embodiments, the candidate composition module may be on a different server. In any case, the request for text candidates associated with the detected text input may be sent via a secure network connecting the secure IME and the candidate composition module.

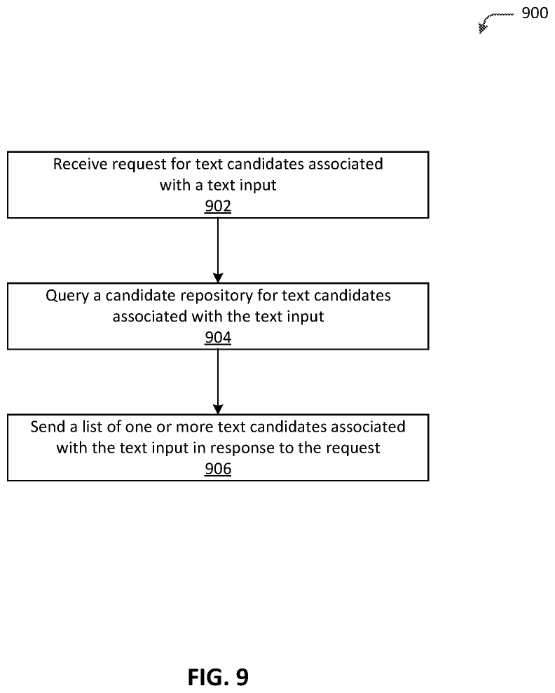

At 808, the secure IME can receive from the candidate composition module a list of one or more text candidates associated with the detected text input. In some embodiments, as will be further described with respect to FIG. 9, the candidate composition module can determine the text candidates using a data repository, such as candidate repository. The list of text candidates associated with the detected text input may be received via the secure network connecting the secure IME and the candidate composition module.

At 810, the secure IME can present the list of one or more text candidates within a candidates window displayed on the client. The candidates window may be a part of a UI of the secure IME. The presented text candidates are in the language selected for the input method of the secure IME.

At 812, the secure IME can receive a selection of one of the text candidates presented in the candidates window. For example, a user accessing the remote application may select a text candidate from the presented list of text candidates and commit the selected text candidate for input to the remote application.

At 814, the secure IME can input the selected one of the text candidates presented in the text candidates window to the UI element of the remote application. The UI element is the UI element associated with the text input detected at 804 above. Subsequent to inputting the selected text candidate to the remote application, the secure IME can close the candidates window displayed on the client.

FIG. 9 is a flow diagram of an illustrative process 900 for determining text candidates associated with a text input, in accordance with an embodiment of the present disclosure. Illustrative process 900 may be implemented, for example, within the client-server computing environment 600 of FIG. 6. In more detail, process 900 may be performed by one or more components of a server, such as server 604, of computing environment 600 of FIG. 6.

Referring to process 900, at 902, a candidate composition module can receive a request for text candidates associated with a text input. The request may be from a secure IME in response the secure IME detecting the text input to a UI element of a remote application running of the server. The request may include an indication of a language associated with the secure IME.

At 904, the candidate composition module can query a candidate repository for text candidates associated with the text input. The text candidates retrieved from the candidate repository may be in the language indicated in the request (e.g., the language associated with the secure IME).

At 906, the candidate composition module can send a list of one or more text candidates retrieved from the candidate repository in response to the received request. For example, the list of text candidates may be sent to the secure IME in response to the request from the secure IME for text candidates associated with the text input.

### Further Example Embodiments

The following examples pertain to further embodiments, from which numerous permutations and configurations will be apparent.

Example 1 includes a method including: detecting, by a first computing device, a text input to a user interface (UI) element of an application executing on the first computing device; responsive to the detection of the text input, sending, by the first computing device to a second computing device, a request for text candidates associated with the text input; responsive to sending the request, receiving, by the first computing device from the second computing device, a list of one or more text candidates associated with the text input; and presenting, by the first computing device, the list of one or more text candidates in a composition window, the composition window being part of an input method editor (IME) executing on the first computing device, the composition window displayed on a screen of the first computing device.

Example 2 includes the subject matter of Example 1, also including, responsive to the detection of the text input, disabling, by the first computing device, a local IME of the first computing device.

Example 3 includes the subject matter of any of Examples 1 and 2, wherein the request for text candidates includes an indication of a language associated with the IME.

Example 4 includes the subject matter of any of Examples 1 through 3, wherein the application is a web application.

Example 5 includes the subject matter of any of Examples 1 through 3, when the application is a Software as a Service (SaaS) application.

Example 6 includes the subject matter of any of Examples 1 through 5, wherein one or more text candidates associated with the text input is determined based on a query of a candidate repository associated with the second computing device.

Example 7 includes the subject matter of any of Examples 1 through 6, wherein the request for text candidates associated with the text input is sent from the first computing device via a secure network to the second computing device.

Example 8 includes a computing device including a processor and a non-volatile memory storing computer program code that when executed on the processor causes the processor to execute a process. The process includes: detecting a text input to a user interface (UI) element of an application executing on the computing device; responsive to the detection of the text input, sending a request for text candidates associated with the text input to a remote computing device; responsive to sending the request, receiving from the remote computing device, a list of one or more text candidates associated with the text input; and presenting the list of one or more text candidates in a composition window, the composition window being part of an input method editor (IME) executing on the computing device, the composition window displayed on a screen of the computing device.

Example 9 includes the subject matter of Example 8, wherein the process also includes, responsive to the detection of the text input, disabling a local IME of the computing device.

Example 10 includes the subject matter of any of Examples 8 and 9, wherein the request for text candidates includes an indication of a language associated with the IME.

Example 11 includes the subject matter of any of Examples 8 through 10, wherein the application is a web application.

Example 12 includes the subject matter of any of Examples 8 through 10, wherein the application is a Software as a Service (SaaS) application.

Example 13 includes the subject matter of any of Examples 8 through 12, wherein one or more text candidates associated with the text input is determined based on a query of a candidate repository associated with the remote computing device.

Example 14 includes the subject matter of any of Examples 8 through 13, wherein the request for text candidates associated with the text input is sent via a secure network to the remote computing device.

Example 15 includes a non-transitory machine-readable medium encoding instructions that when executed by one or more processors cause a process to be carried out. The process includes: detecting a text input to a user interface (UI) element of an application executing on a computing device; responsive to the detection of the text input, sending a request for text candidates associated with the text input to a remote computing device; responsive to sending the request, receiving from the remote computing device, a list of one or more text candidates associated with the text input; and presenting the list of one or more text candidates in a composition window, the composition window being part of an input method editor (IME) executing on the computing device, the composition window displayed on a screen of the computing device.

Example 16 includes the subject matter of Example 15, wherein the process also includes, responsive to the detection of the text input, disabling a local IME of the computing device.

Example 17 includes the subject matter of any of Examples 15 and 16, wherein the request for text candidates includes an indication of a language associated with the IME.

Example 18 includes the subject matter of any of Examples 15 through 17, wherein the application is a web application.

Example 19 includes the subject matter of any of Examples 15 through 17, wherein the application is a Software as a Service (SaaS) application.

Example 20 includes the subject matter of any of Examples 15 through 19, wherein one or more text candidates associated with the text input is determined based on a query of a candidate repository associated with the remote computing device.

Example 21 includes the subject matter of any of Examples 15 through 20, wherein the request for text candidates associated with the text input is sent via a secure network to the remote computing device.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

As used in the present disclosure, the terms “engine” or “module” or “component” may refer to specific hardware implementations configured to perform the actions of the engine or module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modulates executing on a computing system.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect, connecting, and coupling.

All examples and conditional language recited in the present disclosure are intended for pedagogical examples to aid the reader in understanding the present disclosure, and are to be construed as being without limitation to such specifically recited examples and conditions. Although example embodiments of the present disclosure have been described in detail, various changes, substitutions, and alterations could be made hereto without departing from the spirit and scope of the present disclosure. Accordingly, it is intended that the scope of the present disclosure be limited not by this detailed description, but rather by the claims appended hereto.

What is claimed is:

1. A method comprising:
detecting, by a first computing device, a text input to a user interface (UI) element of an application executing on the first computing device;
responsive to the detection of the text input, sending, by the first computing device to a second computing device, a request for text candidates associated with the text input;
responsive to sending the request, receiving, by the first computing device from the second computing device, a list of one or more text candidates associated with the text input; and
presenting, by the first computing device, the list of one or more text candidates in a composition window, the composition window being part of an input method editor (IME) executing on the first computing device, the composition window displayed on a screen of the first computing device.

2. The method of claim 1, further comprising, responsive to the detection of the text input, disabling, by the first computing device, a local IME of the first computing device.

3. The method of claim 1, wherein the request for text candidates includes an indication of a language associated with the IME.

4. The method of claim 1, wherein the application is a web application.

5. The method of claim 1, wherein the application is a Software as a Service (SaaS) application.

6. The method of claim 1, wherein one or more text candidates associated with the text input is determined based on a query of a candidate repository associated with the second computing device.

7. The method of claim 1, wherein the request for text candidates associated with the text input is sent from the first computing device via a secure network to the second computing device.

8. A computing device comprising:
a processor; and
a non-volatile memory storing computer program code that when executed on the processor causes the processor to execute a process including:
detecting a text input to a user interface (UI) element of an application executing on the computing device;
responsive to the detection of the text input, sending a request for text candidates associated with the text input to a remote computing device;
responsive to sending the request, receiving from the remote computing device, a list of one or more text candidates associated with the text input; and
presenting the list of one or more text candidates in a composition window, the composition window being part of an input method editor (IME) executing on the computing device, the composition window displayed on a screen of the computing device.

9. The computing device of claim 8, wherein the process further includes, responsive to the detection of the text input, disabling a local IME of the computing device.

10. The computing device of claim 8, wherein the request for text candidates includes an indication of a language associated with the IME.

11. The computing device of claim 8, wherein the application is a web application.

12. The computing device of claim 8, wherein the application is a Software as a Service (SaaS) application.

13. The computing device of claim 8, wherein one or more text candidates associated with the text input is determined based on a query of a candidate repository associated with the remote computing device.

14. The computing device of claim 8, wherein the request for text candidates associated with the text input is sent via a secure network to the remote computing device.

15. A non-transitory machine-readable medium encoding instructions that when executed by one or more processors cause a process to be carried out, the process including:
detecting a text input to a user interface (UI) element of an application executing on a computing device;
responsive to the detection of the text input, sending a request for text candidates associated with the text input to a remote computing device;
responsive to sending the request, receiving from the remote computing device, a list of one or more text candidates associated with the text input; and
presenting the list of one or more text candidates in a composition window, the composition window being part of an input method editor (IME) executing on the computing device, the composition window displayed on a screen of the computing device.

16. The machine-readable medium of claim 15, wherein the process further includes, responsive to the detection of the text input, disabling a local IME of the computing device.

17. The machine-readable medium of claim 15, wherein the request for text candidates includes an indication of a language associated with the IME.

18. The machine-readable medium of claim 15, wherein the application is a web application or a Software as a Service (SaaS) application.

19. The machine-readable medium of claim 15, wherein one or more text candidates associated with the text input is determined based on a query of a candidate repository associated with the remote computing device.

20. The machine-readable medium of claim 15, wherein the request for text candidates associated with the text input is sent via a secure network to the remote computing device.
